(19) United States
(12) Patent Application Publication
(10) Pub. No.: US 2001/0030977 A1
(43) Pub. Date: Oct. 18, 2001

(54) Proxy methods for IP address assignment and universal access mechanism

(76) Inventor: Lauren T. May, Penngrove, CA (US)

Correspondence Address: MORRISON & FOERSTER LLP, 425 MARKET STREET, SAN FRANCISCO, CA, 94105-2482, US

(21) Appl. No.: 09/745,496

(22) Filed: Dec. 21, 2000

Related U.S. Application Data
(60) Provisional application No. 60/173,855, filed on Dec. 30, 1999.
(60) Provisional application No. 60/173,856, filed on Dec. 30, 1999.

(51) Int. Cl. H04L 12/56; H04J 3/24

(52) U.S. Cl. 370/475; 370/395

(57) ABSTRACT

The present invention encompasses a proxy method for providing an IP address to a computer configured for operation on a wide area network using a local area network address assignment format. The method allows a subscriber side network terminal to receive from a locally attached computer an IP address request in a wide area network compatible format and to obtain from a remote server an IP address using a local area network compatible request.

### CROSS-REFERENCE TO RELATED APPLICATIONS

This application claims the benefit of U.S. Provisional Application No. 60/173,855, entitled “Proxy Method for IP Address Assignment”, and U.S. Provisional Applications No. 60/173,856, entitled “PPPOE Proxy Method”, both of which were filed Dec. 30, 1999. U.S. Provisional Applications Nos. 60/173,855 and 60/173,856 are incorporated herein by reference.

### BACKGROUND OF THE INVENTION

The advent of the Internet with its ability to provide interconnectivity to Web sites and send and receive e-mail to any location in the world has increased the demand for bandwidth. In particular, consumers desire high-speed connections to the Internet. While this demand has previously been met by telephony modems that operate via dial-up connections over analog phone lines, there is a 56 kb/s speed limitation inherent in this technology.

These existing twisted wire pair phone lines can be used to provide high-speed digital connections by using a variety of Digital Subscriber Line technologies, referred to generally as xDSL technology. xDSL technology utilizes the upper frequency of the twisted wire pair to transmit data. In order to communicate over this upper frequency, an high-speed modem is required. A computer is connected to the high-speed modem with a network interface card (NIC). The high-speed modem communicates with a remote terminal connected to the access network over the existing twisted wire pair infrastructure.

High-speed digital connections may also be achieved using coaxial cable available in a hybrid fiber coaxial (HFC) network. In order to communicate over the coaxial cable, a cable modem is required. As with the high-speed modem, the computer needs an NIC to connect to the cable modem. The cable modem communicates with a Cable Modem Termination System (CMTS) over the coaxial cable. The HFC network offers two-way transmission to the Internet at rates of 1-25 Mb/s in the downstream, and rates of 128 kb/s-5 Mb/s in the upstream.

Connectivity to the high-speed network is typically obtained by connecting a physical layer device in a computer, such as an Ethernet card, to the high-speed modem (i.e., xDSL or cable). The high-speed modem connects to the access network and supports connectivity to a gateway-router and ultimately to the Internet. As the NIC is generally required in the computer in order to communicate with the access network, the high-speed digital connections to computers within a residence generally emulate a Local Area Network (LAN). It should be noted that these high-speed connections to the Internet are designed to be active most or all of the time.

Most computer operating systems, including the operating systems distributed by the Microsoft Corporation under the trademarks WINDOWS 95, WINDOWS 98, and WINDOWS NT, utilize a Point-to-Point protocol (PPP) connection that is used in a Wide Area Network (WAN) environment. Consequently, virtually all computer operating systems lack the mechanism to convey PPP packets over a LAN environment, which causes difficulties in obtaining a dynamically assigned Internet Protocol (IP) address for use in the LAN. Moreover, when configured for WAN operation (i.e., PPP) most computers cannot use Dynamic Host Configuration Protocol (DHCP) to obtain an IP address. DHCP allows the user to obtain a dynamic IP address that can be used permanently by a user as long as they renew the lease of the IP address.

For computers configured to operate using the standard Ethernet LAN configuration paradigms (commonly utilized within commercial enterprises where local computer-to-computer communications are required), simple configurations for dial-up type connections are not supported. Users must use complex LAN configuration software, such as a DHCP client, which typically requires an understanding of complex communications protocols. Users desire familiar and simple interfaces for establishing connections to a variety of remote networks.

PPP over Ethernet (PPPoE) protocol described in RFC 2516 provides mechanisms for transporting IP packets encapsulated in PPP over an Ethernet-based LAN. To add PPPoE capability to a computer, a custom software driver often called “shim” is typically required. However, the PPPoE driver differs from one operating system to another. This hinders the wide acceptance of PPPoE and thus is an impediment to the rapid deployment of high-speed access services.

Dial-up graphical user interfaces based on the PPP protocol and corresponding protocols are typically included in modern personal computers. These tools provide the most common and well-understood mechanism for users to access the Internet and other remote networks including private corporate and virtual private networks. This functionality has been developed for use over twisted wire pair networks using analog dial-up modems operating in the voice frequency band.

In addition, Internet service providers (ISP), which have largely invested in technologies to support and provision dial-up Internet access using PPP connection, need high-speed solutions with backward compatibility to their operational and support service (OSS) equipment.

For the foregoing reasons, there is a need for a method and apparatus that acts as a proxy for dynamically providing an IP address to a locally attached computer configured to use a WAN mechanism for IP address acquisition. There is also a need for a PPPoE proxy method for providing a universal access mechanism to broadband services. Moreover there is a need for a platform-independent method for accessing broadband services without further changes in the OSS.

### SUMMARY OF THE INVENTION

In a first embodiment, the present invention provides a method and apparatus for utilizing a Dynamic Host Configuration Protocol (DHCP) in an environment in which a computer would otherwise not be capable of dynamically obtaining an IP address. The present invention can be used when the computer establishes a point-to-point (PPP) session in a wide area network (WAN) configuration to a high-speed access modem.

Present protocols for PPP sessions over WANs do not permit the use of DHCP, thus the present invention allows the DHCP protocol to be operated in an environment in which dynamic IP address assignment would not normally be supported.

An advantage of the present invention is the ability of a computer to establish a PPP connection in a WAN configuration to a high-speed modem, which then establishes a connection through the access network to a DHCP server and obtains an IP address from the server. The computer can utilize this address for the duration of a session by using DHCP lease renewal packets.

Another advantage of the present invention is the ability of the high-speed modem to serve as a proxy device in obtaining IP addresses.

In a second embodiment of the present invention, a method and apparatus for providing a universal access mechanism to broadband services is presented. A broadband device functions as a PPPoE proxy by interfacing a computer using a LAN-based protocol such as Ethernet and a broadband access server (BAS) using the PPPoE protocol. The broadband device is accessed by a computer user using a common mechanism such as an HTML-based browser to request a connection to a public or private network. The broadband device then establishes a PPPoE connection to an access server. The broadband device receives IP packets encapsulated in Ethernet frames from the user's computer and then encapsulates the IP packets into PPP frames that are in turn encapsulated in PPPoE frames. The broadband device performs a series of protocol encapsulation including PPPoE frames into Ethernet frames that are mapped in RFC1483 frames. The RFC1483 frames are in a last step mapped in ATM cells and sent over an xDSL link to the broadband access server.

In the downstream direction ATM cells are received from the BAS and the IP content is extracted, encapsulated in Ethernet frames and then sent to the computer.

These and other features and objects of the invention will be more fully understood from the following detailed description of the preferred embodiments that should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a generic broadband access system;

FIG. 2 illustrates an xDSL based access platform;

FIG. 3 illustrates a detailed xDSL based access platform;

FIG. 4 represents a portion of the xDSL based access platform;

FIG. 5 represents the protocol translation from end-to-end;

FIG. 6 represents a call flow for IP address assignment;

FIG. 7 is a flowchart illustrating the second embodiment of the present invention; and

FIG. 8 illustrates protocol stacks in a computer and in a broadband device for use with the second embodiment of the present invention.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

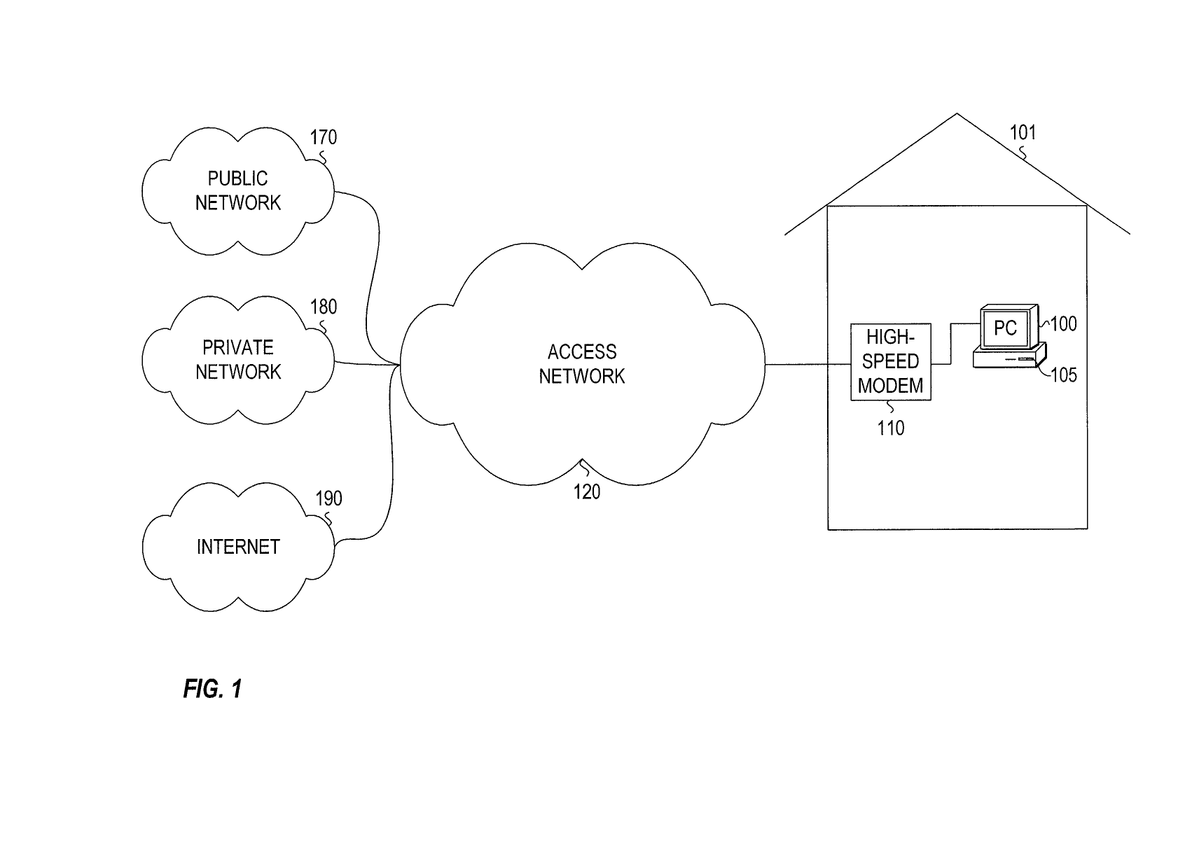

With reference to the drawings, in general, and FIGS. 1 through 8 in particular, the present invention is disclosed.

FIG. 1 illustrates a generic system providing broadband access to a subscriber at residence 101. A computer 100 connected to a high-speed modem 110 via a network interface card (NIC) 105. In a preferred embodiment, the NIC 105 is located within the computer 100. The high-speed modem 110 may be, for example, a Digital Subscriber Line (xDSL) modem or a cable modem. The high-speed modem 110 may be a stand-alone unit, be located within the computer 100, or other device, such as an ETHERset, a Set-Top Box (STB), or a Residential Gateway (RG). If the high-speed modem 110 is contained within the ETHERset it is possible, and likely, that a plurality of computers 100 would be connected to the ETHERset and that the ETHERset would provide high-speed connectivity to the Internet via the access network for the plurality of computers 100.

If the high-speed modem 110 were contained within the RG, in addition to providing high-speed communications with the Internet, the RG would control communications between other Customer Premises Equipment (CPE) and the access network 120. According to a preferred embodiment, the RG provides the interface between the access network 120 and the other CPEs. For example, the RG may act as: (1) an STB, to convert digital video signals to analog signals compatible with a TV; (2) an Ethernet Bridge or Router (EBR), to generate a signal compatible with the computer; and (3) a Premises Interface Device (PID), to extract time division multiplexed information and generate a telephone signal compatible with a telephone.

In a preferred embodiment, the high-speed modem is the N³ residential gateway produced by Next Level Communications (NLC), Rohnert Park, Calif. Various embodiments of the RG are described in the following co-pending U.S. Applications assigned to NLC:

Ser. No. 09/026,038 entitled “In-Home Wireless”, and Ser. No. 09/026,036 entitled “Video, Data and Telephony Gateway” both filed on Feb. 19, 1998;

Ser. No. 09/525,488 entitled “Method and Apparatus for Transmitting Wireless Signals Over Media”, Ser. No. 09/526,100 entitled “Optical Conversion Device”, and Ser. No. 09/525,412 “Media Interface Device” all of which were filed on Mar. 15, 2000; and

Ser. No. 09/612,562 entitled “Wireless and xDSL Residential Gateway and System” filed on Jul. 7, 2000.

All of the above applications are herein incorporated by reference, but are not admitted to be prior art.

The high-speed modem 110 connects the user to an access network 120. The access network 120 provides access to a public network 170, a private network 180 as well as the Internet 190. The access network 120 may be a hybrid fiber coax (HFC) network, a fiber-to-the-curb (FTTC) network, fiber-to-the-home (FTTH) network, a digital subscriber line (DSL)-based access network, or other access networks that are now known or later conceived.

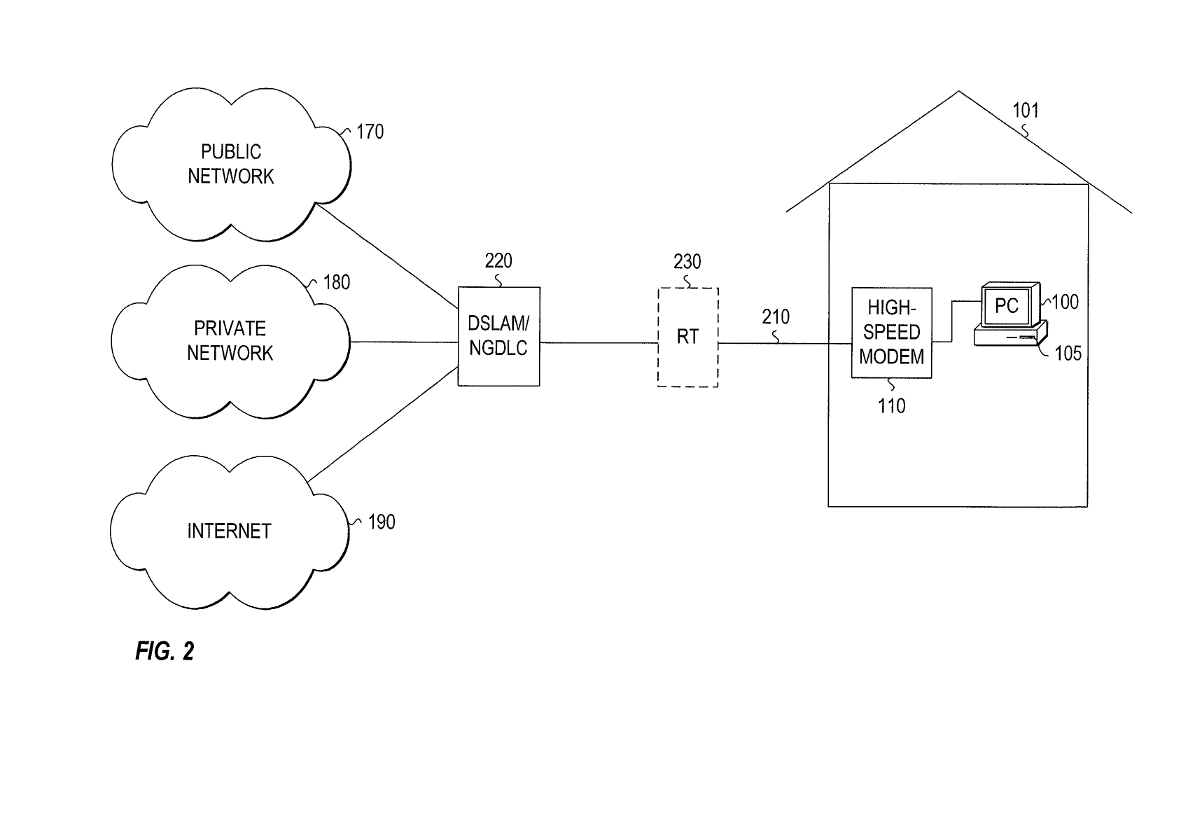

FIG. 2 illustrates an embodiment that utilizes a DSL-based access network as the access network. In this embodiment, high-speed modem 110 is connected to the access network through an xDSL link 210 running on a twisted wire pair. According to one embodiment, the xDSL link 210 is terminated within the access network at a Digital Subscriber Line Access Multiplexer (DSLAM) or a Next Generation Digital Loop Carrier (NGLDC), hereinafter referred to as DSLAM/NGDLC 220. The termination point in the access network is a DSLAM or NGDLC depending on the provider of the access network and other factors that would be obvious to those skilled in the art. The DSLAM/NGDLC 220 can be located in the field as part of a central office configuration, remotely located enclosure, or in a customer premises, typically an apartment or office building. The DSLAM/NGDLC 220 contains linecards with high-speed modems that can support analog phone services, high-speed data and video. In the downstream direction, the DSLAM/NGDLC 220 multiplexes both analog phone signals, high-speed data and video into the xDSL link 210.

According to one embodiment, the access network also includes a Remote Terminal (RT) 230 downstream from the DSLAM/NGDLC 220. The RT 230 allows the access network to reach more subscribers over greater distances as the DSLAM/NGDLC 220 transmits data to numerous RTs 230 and the RTs 230 transmit the data to numerous subscribers. In this embodiment, the xDSL link 210 would be terminated at the RT 230.

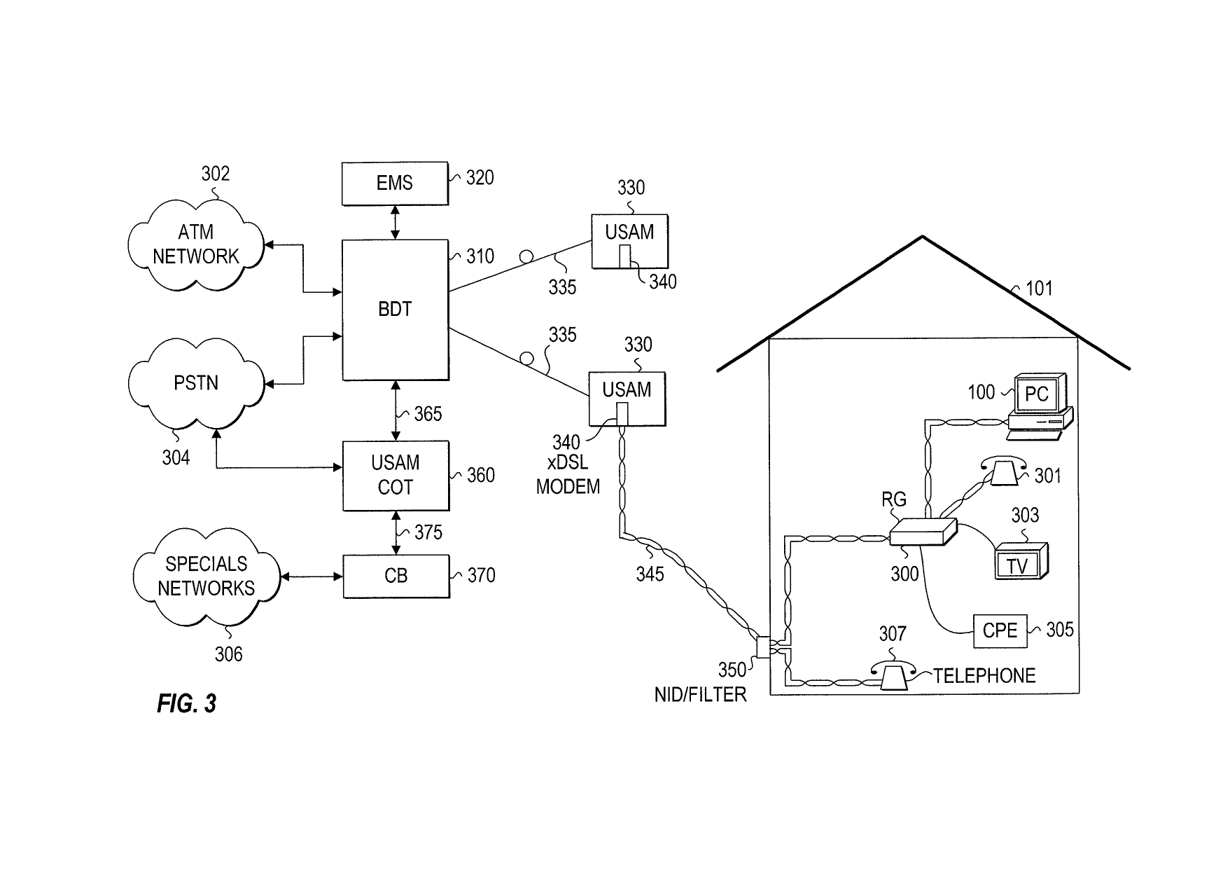

In a preferred embodiment, the access network is a DSL-based access network deployed by NLC. FIG. 3 illustrates a DSL-based access network that includes a Broadband Digital Terminal (BDT) 310 connected to a Public Switched Telecommunications Network (PSTN) 304 and Asynchronous Transfer Mode (ATM) network 302. The BDT 310 can also receive special service signals from private or non-switched public networks 306. An Element Management System (EMS) 320 is connected to the BDT 310 and forms part of an Element Management Layer (EML) that is used to provision services and equipment on the DSL network.

A Universal Service Access Multiplexer (USAM) 330 is located in the serving area, and is connected to the BDT 310 via optical fiber 335. The USAM 330 includes an high-speed modem 340 that provides for the transmission of high-speed digital data to and from the residence, over a twisted wire pair, drop line cable 345. Traditional analog telephone signals are combined with the digital signals for transmission to the residence 101. A NID/filter 350 is used to separate the analog telephone signals from the digital signals and is also connected to a phone 307.

A USAM Central Office Terminal (COT) 360 is also connected to the BDT 310. The USAM COT 360 supports twisted wire pair interfaces to the PSTN 304 (including DS-1 interfaces). A Channel Bank (CB) 370 is located within the central office. The CB 370 is used to connect special networks 306 comprised of signals from private or public networks, to the DSL-based access network.

FIG. 3 illustrates an embodiment where a high-speed broadband device, represented herein as residential gateway 300, supports voice, data and video. The RG 300 connects a telephone device 301, a TV 303, a PC 100 and other CPE 305 to the access network to receive services delivered to the residence 101.

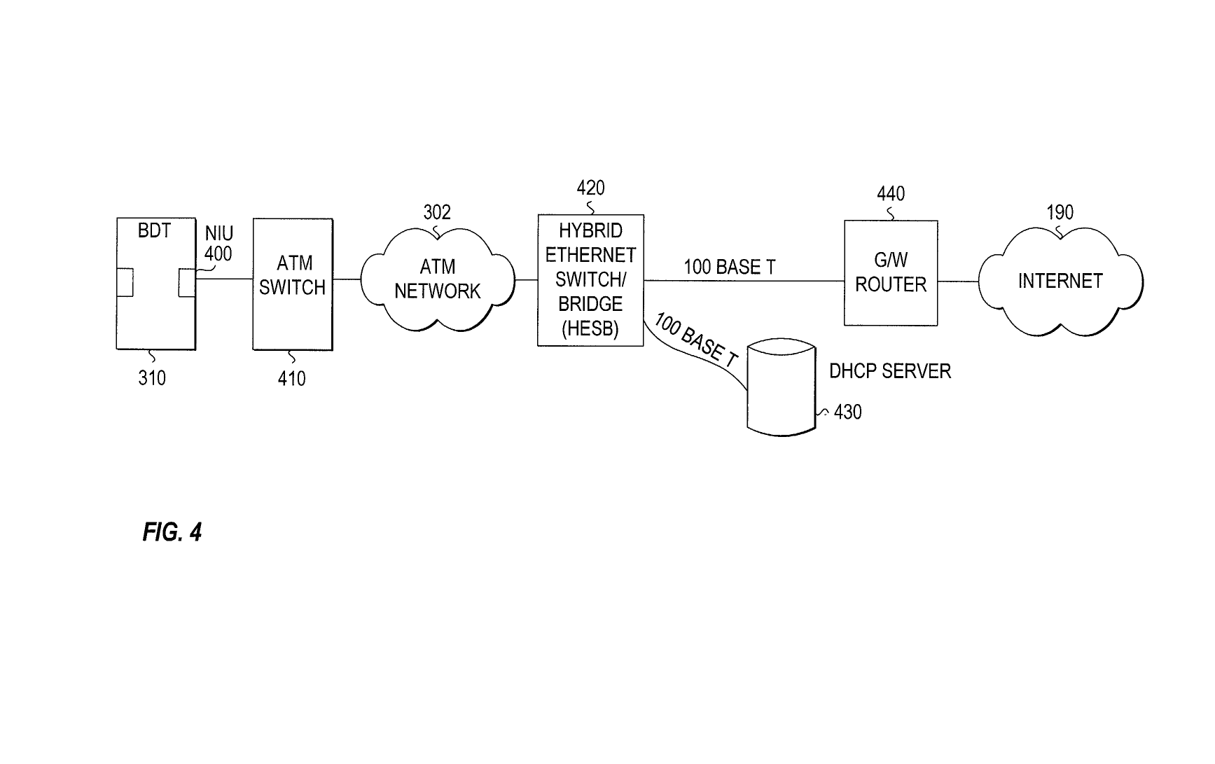

FIG. 4 illustrates one embodiment of a portion of the DSL access system connecting to the Internet. As illustrated, the BDT 310 includes a Network Interface Unit (NIU) 400 for receiving video and data services from the ATM network 302. An ATM switch 410 may be present if data is being received from multiple ATM networks. The ATM network 302 is connected to a hybrid Ethernet switch/bridge (HESB) 420 for providing ATM cell switching and bridging for LAN attached devices. The HESB 420 may be a Catalyst 5500 manufactured by Cisco or others that are well known to those skilled in the art.

The HESB 420 can switch traffic to a Dynamic Host Configuration Protocol (DHCP) server 430 and a gateway/router 440. The DHCP server 430 is accessed when an IP address is requested by a LAN attached device. An IP address request may be transmitted in an ATM cell with a previously assigned Virtual Path Identifier/Virtual Channel Identifier (VPI/VCI), which can either be dedicated for the acquisition of addresses using DHCP or can be shared for IP address acquisition as well as for data transport. The gateway/router 440 provides connectivity from the access network to the Internet 190 and vice versa.

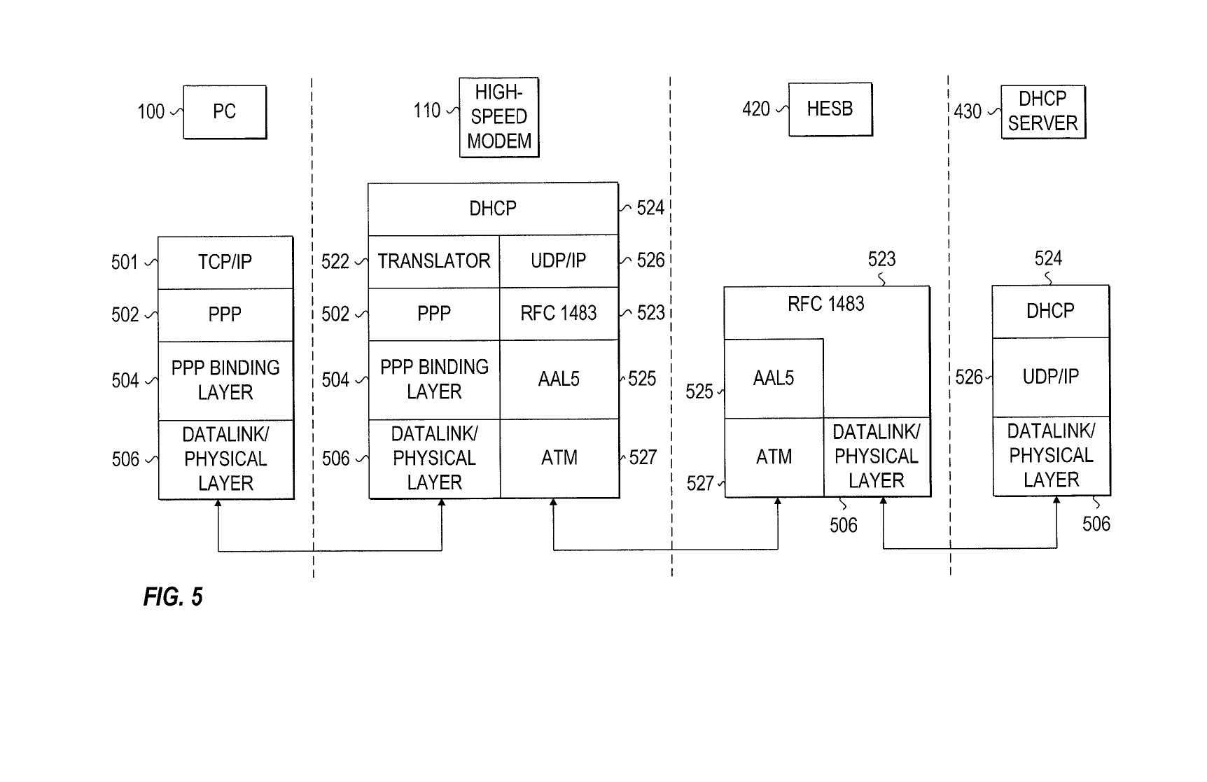

Referring now to FIG. 5, the protocol suites from the computer 100 to the DHCP server 430 are illustrated. FIG. 5 illustrates the different layers involved in the acquisition and assignment of an IP address. The computer 100 can be running a Windows 95/NT operating system or any other operating system that supports dial-up networking. The protocol suite in the computer 100 includes a TCP/IP layer 501, a point-to-point protocol (PPP) layer 502, a PPP binding layer 504 and the data link/physical layer 506. The Transmission Control Protocol/Internet Protocol (TCP/IP) and PPP protocols are well known to those skilled in the art. The data link/physical layer 506 can be based on the Ethernet standard, which uses the IEEE 802.3 standard. The IEEE 802.3 standard encompasses the Medium Access Control (MAC) protocol and the physical layer specifications and is also well known to those skilled in the art.

The protocol stacking depicts a situation where the computer 100 is attached to a network through a LAN device such as NIC 105, as illustrated in FIG. 1. In this embodiment, the PPP binding layer 504, interposed between PPP 502 and data link/physical layer 506 binds PPP 502 to the high-speed modem 110. The PPP binding layer 504 allows the computer 100 to run a PPP session in a LAN environment. The PPP binding layer 504 can use any protocol that binds PPP into a specific network interface. In a preferred embodiment, PPP binding layer 504 uses PPP over Ethernet (PPPoE) that is disclosed in RFC 2516, “A Method for Transmitting PPP over Ethernet (PPPoE),” by Mamakos et al. and which is incorporated herein by reference. The use of PPPoE will be described in more detail later.

In a preferred embodiment, the computer 100 communicates via the NIC 105 to the high-speed modem 110 to establish a PPP session. In establishing a PPP session, the computer 100 sends PPP messages encapsulated over Ethernet packets to high-speed modem 110 that generates DHCP packets to request an IP address. The protocol stack in high-speed modem 110 comprises the peers of the protocols in computer 100 and NIC 105 up to the PPP layer 502. A Translator 522 is a relay/translation function between the PPP layer 502 and the DHCP layer 524, which converts packets from the PPP format into DHCP format. The DHCP layer 524 translates the PPP messages into DHCP messages. The DHCP layer 524 uses User Datagram Protocol/Internet Protocol (UDP/IP) 526 to communicate with the DHCP server 430.

In a preferred embodiment, the “Multiprotocol Encapsulation over ATM Adaptation Layer 5” by Juha Heinanen which is disclosed in RFC 1483 and is represented here as RFC 1483 layer 523 is used to encapsulate network layer messages over ATM AAL5. RFC 1483 is incorporated herein by reference. The RFC 1483 layer 523 takes the IP datagrams from UDP/IP 523 and encapsulates them over the ATM Adaptation Layer 5 (AAL5) 525. The cells obtained from the ATM layer 527 are sent up the xDSL link 345 (shown in FIG. 3) to the HESB 420. The ATM cells are encoded to the physical layer protocol format defined in xDSL recommendations. The HESB 420 has a protocol stack that includes an ATM layer 527, an AAL5 layer 525 and an RFC 1483 layer 523. The HESB 420 performs the de-encapsulation necessary to retrieve the UDP/IP packet sent by the high-speed modem 110. The retrieved UDP/IP packet is sent through the data link/physical layer 506 to the DHCP server 430. The protocol stack at the DHCP server 430 includes the data link/physical layer 506, the UDP/IP 526 and the DHCP layer 524.

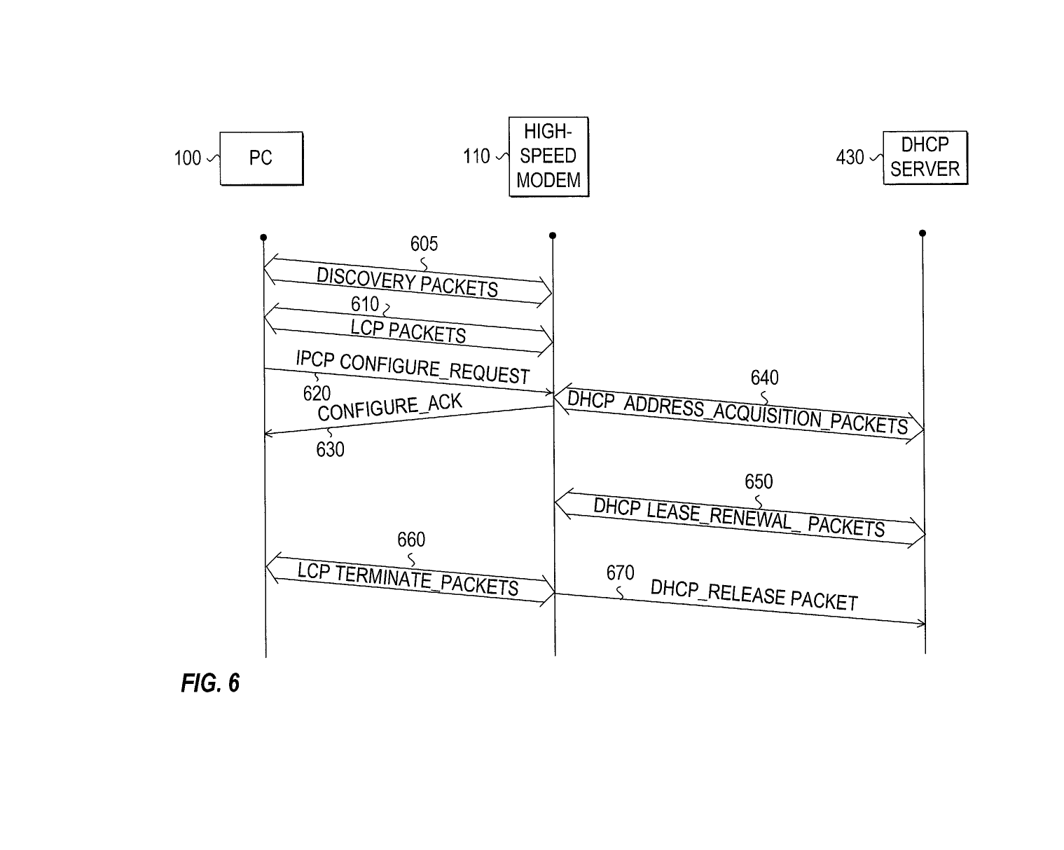

FIG. 6 shows the call flow for assigning an IP address to the computer 100. In a preferred embodiment, the computer 100 opens a PPP session with high-speed modem 110 by dialing in to high-speed modem 110. Establishing a PPP session is well known to those skilled in the art and is described by W. Simpson in document RFC 1548 entitled “The Point-to-Point Protocol (PPP),” which is herein incorporated by reference.

In this embodiment, when the computer 100 wishes to start a PPP session, the PPP binding layer 504 that uses PPPoE performs first a discovery to identify the Ethernet MAC address of high-speed modem 110 and establish a PPPoE SESSION_ID. After the discovery stage, a PPP session can be opened between the computer 100 and the high-speed modem 110. The computer 100 and the high-speed modem 110 can then exchange Link Control Packets (LCP) 610 to establish, configure and test the data link. After the link is established, PPP 502 sends Network Control Protocol (NCP) packets to choose and configure one or more network layer protocols. In this instance, NCP is the Internet Protocol Configuration Protocol (IPCP). IPCP is responsible for configuring, enabling and disabling the PPP communication between the IP protocol modules at both ends of the PPP link. This protocol is disclosed in RFC 1332 by McGregor entitled “The PPP Internet Protocol Control Protocol” and is herein incorporated by reference.

PPP 502 in computer 100 sends an IPCP Configure-Request 620 to PPP 502 in high-speed modem 110. The IPCP Configure_Request 620 requests that the peer issues an IP address for computer 100. This request is translated into a DHCP request for an IP address.

The high-speed modem 110, through its DHCP layer 524, can function as a DHCP client. The DHCP client exchanges DHCP Address_Acquisition_Packets 640 with the DHCP server 430 to obtain an IP address for computer 100. DHCP Address_Acquisition_Packets 640 includes all packets sent between the DHCP client and the DHCP server 430 for obtaining an IP address. Document RFC 1541 by R. Droms “Dynamic Host Configuration Protocol” discloses the DHCP protocol and is herein incorporated by reference. The IP address is forwarded to computer 100 in an IPCP Configure_ACK 630. The high-speed modem 110 continues sending DHCP Lease_Renewal_Packets 650 to the DHCP server 430 to renew the lease of the IP address. DHCP Lease_Renewal_Packets 650 includes all DHCP packets sent between the DHCP client and the DHCP server 430 for lease renewal. Computer 100 can exchange LCP Terminate_Packets 660 with high-speed modem 110 to terminate the data link. LCP Terminate_Packets 660 includes all LCP packets sent between PPP peers to terminate a PPP session. Upon receiving a request to terminate the PPP session, high-speed modem 110 sends a DHCP_Release packet 670 to the DHCP server 430.

As discussed earlier, the high-speed modem 110 may be a broadband device such as an ETHERset, STB or RG. In this embodiment, the broadband device is used as a PPPoE proxy to establish a PPPoE connection to an access server. The term broadband device will be used in the remainder of the text to designate the high-speed modem.

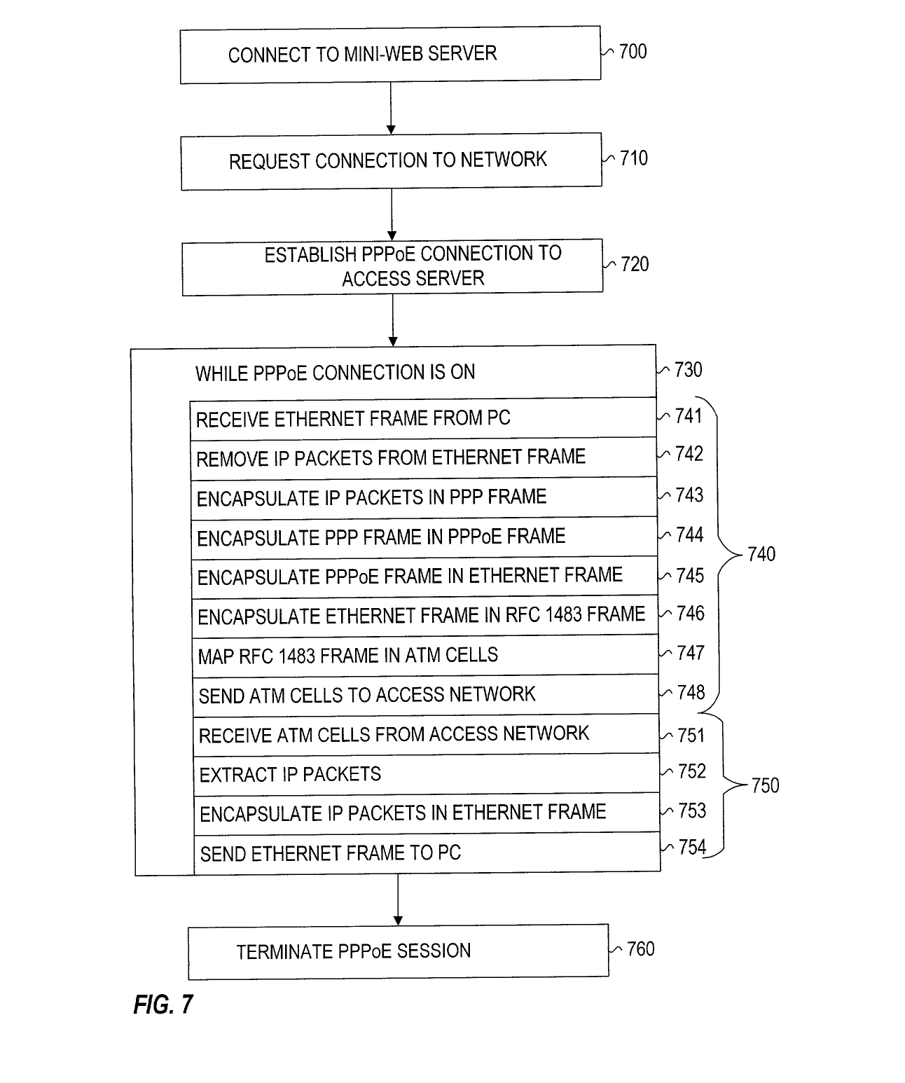

FIG. 7 illustrates an exemplary embodiment for establishing such a connection. The broadband device acts as a proxy by interfacing computers and other CPE through a LAN protocol such as Ethernet and an access server using a PPPoE connection. In this embodiment, the PPPoE layer is implemented in the broadband device as opposed to implementing that layer in every PC connected to the broadband device. The broadband device encapsulates and de-encapsulates packets transferred between the broadband access network and the LAN.

A user can access different networks using a mini-web server embedded in the broadband device. The user connects to the mini web-server via a browser installed in the user's computer 100. The user can choose among different destinations as to what network connection they desire (step 710). In one embodiment, the broadband device establishes a PPPoE session with an access server (step 720). The mechanism for establishing a PPPoE session is well known to those skilled in the art and is described in RFC 2516.

In one preferred embodiment, the broadband device performs a continuous loop while the PPPoE connection is active (step 730). The continuous loop of step 730 includes steps performed in the upstream path (step 740) and those performed in the downstream path (step 750).

In the upstream path, the broadband device receives an Ethernet frame containing an IP packet (step 741) and removes the IP packet from the Ethernet frame (step 742). The IP packet is then encapsulated into a PPP frame (step 743) that is then encapsulated into a PPPoE frame (step 744). The PPPoE frame is encapsulated in an Ethernet frame (step 745) that is encapsulated in an RFC 1483 frame (step 746) according to the multiprotocol encapsulation over ATM adaptation layer 5, described in RFC 1483. The RFC 1483 frame is mapped in ATM cells (step 747) and then sent to the broadband access server via an xDSL link (step 748).

In the downstream path the broadband device receives ATM cells sent by the access network (step 751) and extracts the IP packets contained in the ATM cells (step 752). Thereafter, the IP packets are encapsulated in Ethernet frames (step 753). The broadband device can then send the IP packets embedded in Ethernet frames to the user's computer 100 (step 754). The system performs the different operations described in loop 730 while the PPPoE session is active and terminates the PPPoE session when the user requests a disconnection from the network (step 760).

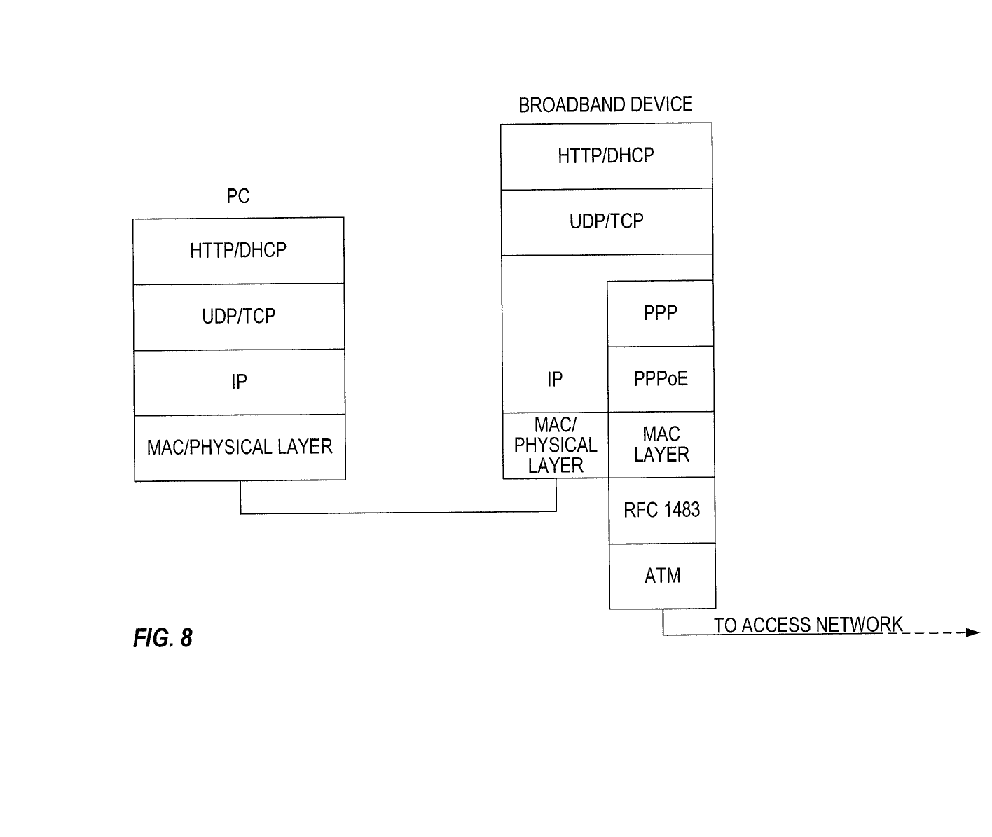

FIG. 8 shows the protocol stacks that can be included in the user's computer 100 and the broadband device. In computer 100, the protocol stack includes at the application layer a HTTP client and a DHCP client. The DHCP client is used by the computer to acquire an IP address from the broadband device. Other mechanisms for IP address acquisition can also be used by the computer and include static address assignment and network address translation. In a preferred embodiment, the IP address acquired by the computer is used to access the mini-web server embedded in the broadband device. A browser in the computer uses the HTTP client to connect to the mini-web server.

At the transport and network level the suite of protocols UDP/TCP/IP are used to run over the MAC/Physical layer that may be based on the IEEE 802.3 standard.

The protocol stack of the broadband device includes a LAN side (left side) and an xDSL side (right side). On the LAN side, the protocol stack includes the peers of computer 100 as illustrated in FIG. 8. On the xDSL link side the protocol suite includes an HTTP/DHCP layer, an UDP/TCP layer, a PPP layer, a PPPoE layer and a MAC layer such as an Ethernet layer as defined in the IEEE 802.3 standard. An RFC 1483 client is also present to map Ethernet frames into ATM cells that are sent over the xDSL link.

Although this invention has been illustrated by reference to specific embodiments, it will be apparent to those skilled in the art that various changes and modifications may be made, which clearly fall within the scope of the invention. The invention is intended to be protected broadly within the spirit and scope of the appended claims.

What is claimed is:

1. In a data access system, a method of providing an Internet Protocol (IP) address for a computer device, said method comprising:
a) receiving a request from said computer device for an IP address at a subscriber side network terminal, wherein said computer is configured for operation on a wide area network, and wherein said request is in a format compatible with a wide area network;
b) translating the request from the format compatible with a wide area network into a local area network compatible request; and
c) obtaining an IP address for said computer device.

2. The method of claim 1 wherein the local area network compatible request is a dynamic host configuration protocol request.

3. The method described in claim 1 further characterized in that said computer device establishes a Point-to-Point protocol (PPP) session with said subscriber side network terminal connected to said computer device.

4. The method described in claim 1 wherein said request takes place within a point-to-point protocol session established between said computer device and said subscriber side network terminal.

5. The method described in claim 1 further characterized in that said subscriber side network terminal periodically renews an IP address lease for said IP address.

6. The method of claim 1 wherein said subscriber side terminal periodically renews said IP address lease for said IP address using Dynamic Host Configuration Protocol (DHCP) lease renewal packets.

7. An apparatus for providing connectivity to the Internet over a high speed access network, said apparatus comprising:
a) a protocol stack for receiving a request from a computer device for an IP address, wherein said request is in a format compatible with a wide area network; and
b) a translator for translating said request from said format compatible with a wide area network into a local area network compatible request.

8. The apparatus of claim 7 wherein the local area network compatible request is a dynamic host configuration protocol (DHCP) request.

9. The apparatus of claim 7 wherein said apparatus supports a connection to a twisted wire pair network using xDSL transmission.

10. The apparatus of claim 7 wherein said apparatus supports a connection to a hybrid fiber coaxial cable network.

11. A method for use in a network environment for an assignment of Internet Protocol (IP) address, the method comprising:
a) establishing a local Point-to-Point Protocol (PPP) session between a computer device and a local network interface device to acquire an IP address for the computer device;
b) using a Dynamic Host Configuration Protocol (DHCP) between the local network interface device and a remote server to acquire the IP address; and
c) relaying said IP address to the computer device using a PPP-based message.

12. The method of claim 11 further comprising:
d) periodically sending from the local network interface device a lease renewal message to the server to renew the IP address.

13. A proxy method for a universal access mechanism to a broadband access system, the method comprising:
a) requesting a connection to a broadband access network through a network interface device from a Local Area Network (LAN)-attached device;
b) establishing a Point-to-Point Protocol Over Ethernet (PPPoE) connection to an access server connected to said broadband access network;
c) performing protocol encapsulation and de-encapsulation for relaying messages transmitted between the broadband access network and the LAN-attached device for the duration of the PPPoE connection.
